(19) United States
(12) Patent Application Publication
(10) Pub. No.: US 2026/0086941 A1
(43) Pub. Date: Mar. 26, 2026

(54) SYSTEMS AND METHODS FOR HIGH FIDELITY REGION FROM PROBE FILTER ENTRY

(71) Applicant: Advanced Micro Devices, Inc., Santa Clara, CA (US)

(72) Inventors: Ganesh Balakrishnan, Austin, TX (US); Shaoming Chen, Austin, TX (US); Kevin M. Lepak, Austin, TX (US); Amit P. Apte, Austin, TX (US)

(73) Assignee: Advanced Micro Devices, Inc., Santa Clara, CA (US)

(21) Appl. No.: 18/896,772

(22) Filed: Sep. 25, 2024

(51) Int. Cl. G06F 12/0802

(52) U.S. Cl. CPC G06F 12/0802; G06F 2212/60

(57) ABSTRACT

A computing system includes a processing node having one or more processors and a cache subsystem, and a region-based probe filter directory having a first and second entry, the first entry containing information of a region of a memory, the second entry containing information of a line in the region of the memory, data stored in the region being cached in the cache subsystem. Various other methods and systems are also disclosed.

### BACKGROUND

Computer systems use main memory that is typically formed with inexpensive and high density dynamic random access memory (DRAM) chips. However, DRAM chips suffer from relatively long access times. To improve performance, a computer system typically includes at least one local, high-speed memory known as a cache. In a multi-core data processor, each data processor core can have its own dedicated level one (L1) cache, while other caches (e.g., level two (L2), level three (L3)) are shared by data processor cores.

Cache subsystems in a computing system include high-speed cache memories configured to store blocks of data. As used herein, a “block” is a set of bytes stored in contiguous memory locations, which are treated as a unit for coherency purposes. As used herein, each of the terms “cache block”, “block”, “cache line”, and “line” is interchangeable. In some examples, a block can also be the unit of allocation and deallocation in a cache. The number of bytes in a block is varied according to design choice, and can be of any size. In addition, each of the terms “cache tag”, “cache line tag”, and “cache block tag” is interchangeable.

In multi-node computer systems, special precautions must be taken to maintain coherency of data that is being used by different processing nodes. For example, if a processor attempts to access data at a certain memory address, it must first determine whether the memory is stored in another cache and has been modified. To implement this cache coherency protocol, caches typically contain multiple status bits to indicate the status of the cache line to maintain data coherency throughout the system. One common coherency protocol is known as the “MOESI” protocol. According to the MOESI protocol, each cache line includes status bits to indicate which MOESI state the line is in, including bits that indicate that the cache line has been modified (M), that the cache line is exclusive (E) or shared(S), or that the cache line is invalid (I). The Owned (O) state indicates that the line is modified in one cache, that there may be shared copies in other caches and that the data in memory is stale.

Cache directories are a key building block in high performance scalable systems. A cache directory is used to keep track of the cache lines that are currently in use by the system. A cache directory improves both memory bandwidth as well as reducing probe bandwidth by performing a memory request or probe request only when required. Logically, the cache directory resides at the home node of a cache line which enforces the cache coherence protocol. The operating principle of a cache directory is inclusivity (i.e., a line that is present in a central processing unit (CPU) cache must be present in the cache directory). The size of the cache directory increases linearly with the total capacity of all of the CPU cache subsystems in the computing system. Over time, CPU cache sizes have grown significantly. As a consequence of this growth, cache directory has become very large.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary computing system.

FIG. 2 is a block diagram of an exemplary core complex.

FIG. 3 is a block diagram of an exemplary multi-CPU system.

FIG. 4 is a block diagram of an implementation of a cache directory.

FIG. 5 is a block diagram of another implementation of a cache directory.

FIG. 6 is a block diagram of an implementation of an associated entry for a region-based probe filter directory.

FIG. 7 is a block diagram of an exemplary region-based probe filter directory.

FIG. 8 is a block diagram of another exemplary region-based probe filter directory.

FIG. 9 is a flowchart illustrating an exemplary process for constructing an associated entry.

FIG. 10 is a flowchart illustrating another exemplary process for constructing an associated entry.

FIG. 11 is a flowchart illustrating an exemplary process of evicting an associated entry to make a slot available for a new regular entry in a region-based probe filter directory.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to probe filters for enhancing cache coherency in a computing system. Specifically, the disclosed probe filters construct an associated entry to accompany a regular entry in a region-based probe filter directory for a cached region in a memory. The associated entry includes information of individual lines within the cached region, so that the cached region can be tracked more finely and to avoid false sharing and overcrowding a line-based probe filter directory within the probe filter. The “false sharing” is a unique situation to the region-based probe filter direction in which a memory region is shared by two or more processing nodes, but the processing nodes are accessing different lines within the memory region.

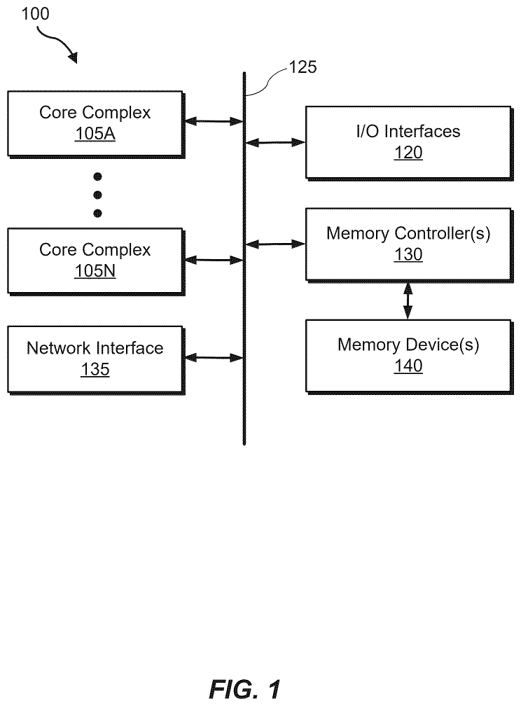

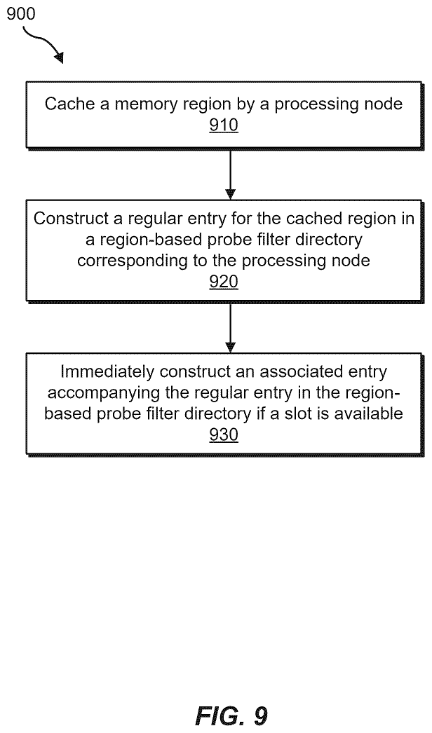

The following will provide, with reference to FIGS. 1-8, detailed descriptions of example systems for probe filter directory. Detailed descriptions of corresponding computer-implemented methods will also be provided in connection with FIGS. 9-11.

An exemplary computing system includes a processing node having one or more processors and a cache subsystem, and a region-based probe filter directory having a first and second entry, the first entry containing information of a region of a memory, the second entry containing information of a line in the region of the memory, data stored in the region being cached in the cache subsystem, wherein the first entry includes a tag field pointing to the region of the memory, and the second entry includes state information of a line in the region of the memory. As the first entry contains mostly region related information, and thus is referred to as a regular entry for a region-based probe filter directory. As the second entry contains mostly information of lines within a region, and thus is referred to as an associated entry.

In an implementation, the second or associated entry is evicted upon the processing node is caching another region of the memory and the associated entry remains solely accessed by the processing node.

In another implementation, the first (regular) and second (associated) entries are located next to each other.

In another implementation, the first (regular) entry includes one or more bits pointing to a location of the second (associated) entry.

In another implementation, the first (regular) and second (associated) entry are constructed simultaneously upon the region of the memory being cached by the cache subsystem.

In another implementation, the second (associated) entry also identifies other processing nodes owning a line in the region of the memory.

In another implementation, the second (associated) entry is constructed upon the other processing node accessing the line in the region of the memory.

FIG. 1 is a block diagram of an exemplary computing system 100. As illustrated in this figure, exemplary computing system 100 includes at least core complexes 105A-N, input/output (I/O) interfaces 120, bus 125, memory controller 130, network interface 135, and memory device 140. In other implementations, computing system 100 can include other components and/or computing system 100 can be arranged differently. In an implementation, each core complex 105A-N includes one or more general purpose processors, such as central processing units (CPUs). It is noted that a “core complex” can also be referred to as a “processing node” a “CPU”, a “processor”, or an “accelerator” herein. In some implementation, one or more core complexes 105A-N can include a data parallel processor with a highly parallel architecture. Examples of data parallel processors include graphics processing units (GPUs), digital signal processors (DSPs), field programmable gate arrays (FPGAs), application specific integrated circuits (ASICs), and so forth. Each processor core within core complex 105A-N includes a cache subsystem with one or more levels of caches. In an example, each core complex 105A-N includes a cache (e.g., level three (L3) cache) which is shared between multiple processor cores.

Memory controller(s) 130 are representative of any number and type of memory controllers accessible by core complexes 105A-N. Memory controller(s) 130 are coupled to any number and type of memory devices 140. Depending on implementations, the type of memory in memory devices 140 coupled to memory controllers 130 can include Dynamic Random Access Memory (DRAM), Static Random Access Memory (SRAM), NAND Flash memory, NOR Flash memory, Ferroelectric Random Access Memory (FeRAM), or other types.

I/O interfaces 120 are representative of any number and type of I/O interfaces (e.g., peripheral component interconnect (PCI) bus, PCI-Extended (PCI-X), PCI Express (PCIe) bus, gigabit Ethernet (GBE) bus, universal serial bus (USB)). Various types of peripheral devices can be coupled to I/O interface 120. Such peripheral devices include (but are not limited to) displays, keyboards, mice, printers, scanners, joysticks or other types of game controllers, media recording devices, external storage devices, network interface cards, and so forth.

In various implementations, computing system 100 can be a server, personal computer, laptop, mobile device, game console, streaming device, wearable device, or any of various other types of computing systems or devices. It is noted that the number of components in computing system 100 can vary from implementation to implementation. There can be more or fewer of each component than the number shown in FIG. 1. It is also noted that computing system 100 can include other components not shown in FIG. 1. Additionally, in other implementations, computing system 100 can be structured in other ways than shown in FIG. 1.

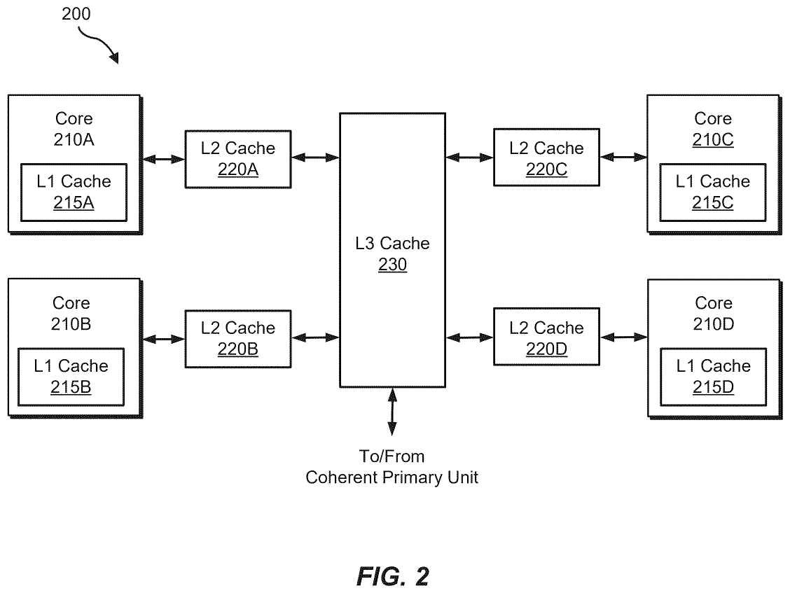

FIG. 2 is a block diagram of an exemplary core complex 200. In one implementation, core complex 200 includes four processor cores 210A-D. In other implementations, core complex 200 can include other numbers of processor cores. It is noted that a “core complex” can also be referred to as a “processing node”, “accelerator”, “processor” or “CPU” herein. In one example, the components of core complex 200 are included within core complexes 105A-N of FIG. 1.

Each processor core 210A-D includes a cache subsystem for storing data and instructions retrieved from the memory subsystem (not shown). For example, each core 210A-D includes a corresponding level one (L1) cache 215A-D. Each processor core 210A-D can include or be coupled to a corresponding level two (L2) cache 220A-D. Additionally, in one implementation, core complex 200 includes a level three (L3) cache 230 which is shared by the processor cores 210A-D exemplarily through L2 caches 220A-D. L3 cache 230 is also exemplarily coupled to a coherent moderator (not shown) for access to the fabric and memory subsystem. It is noted that in other embodiments, core complex 200 can include other types of cache subsystems with other numbers of caches and/or with other configurations of the different cache levels.

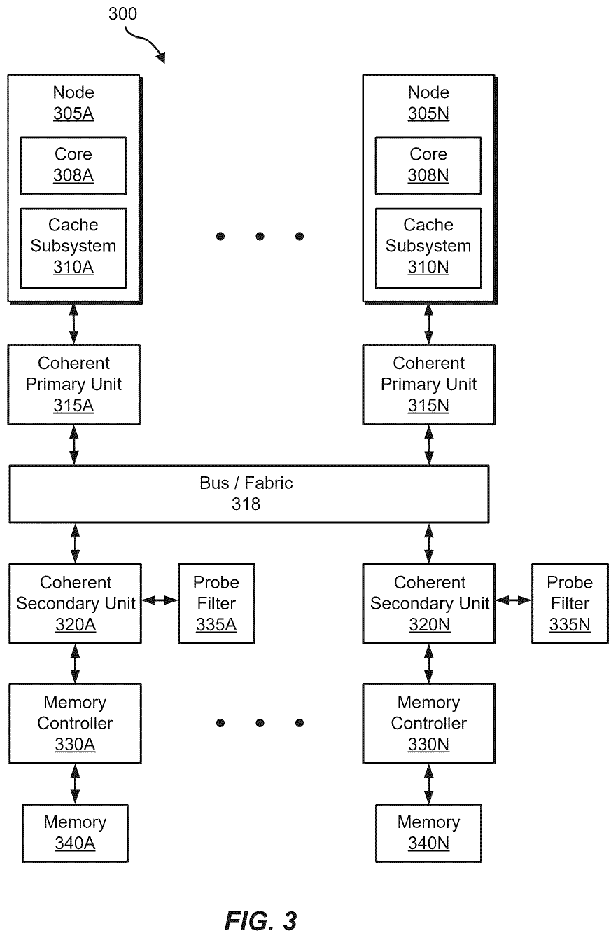

FIG. 3 is a block diagram of an exemplary multi-CPU system 300. System 300 includes multiple nodes 305A-N, with the number of nodes per system varying from implementation to implementation. Each node 305A-N can include any number of cores 308A-N, respectively, with the number of cores varying according to the implementation and from node to node. Each node 305A-N also includes a corresponding cache subsystem 310A-N, respectively. Each cache subsystem 310A-N can include any number of cache levels and any type of cache hierarchical structure.

In one implementation, each node 305A-N is coupled to a corresponding coherent primary unit 315A-N. As used herein, a “coherent primary unit” is defined as an agent that processes traffic flowing over an interconnect (e.g., bus/fabric 318) and manages coherency for a connected node. To manage coherency, a coherent primary unit 315A-N receives and processes coherency-related messages and probes and generates coherency-related requests and probes.

In one implementation, each node 305A-N is coupled to a corresponding coherent secondary (CS) unit 320A-N via a corresponding coherent primary unit 315A-N and bus/fabric 318. For example, node 305A is coupled through coherent primary unit 315A and bus/fabric 318 to coherent secondary unit 320A. Coherent secondary unit 320A is coupled to memory 340A via memory controller (MC) 330A. Coherent secondary unit 320A is also coupled to or includes probe filter 335A, with probe filter 335A including entries for cache lines cached in system 300 for the memory 340A accessible through memory controller 330A. Probe filter 335A determines whether to issue a probe to at least one other processing node in response to a memory access request.

It is noted that probe filter 335A, and each of the other probe filters, can also be referred to as a “cache directory”. It is also noted that the example of having one memory controller per node is merely indicative of one implementation. It should be understood that in other implementations, each node 305A-N can be connected to other numbers of memory controllers.

In a similar configuration to that of node 305A, node 305N is coupled to coherent secondary units 320N via coherent primary unit 315N and bus/fabric 318. Coherent secondary unit 320N is coupled to or includes probe filter 335N for coherency purposes, and coherent secondary unit 320N is coupled to memory 340N via memory controllers 330N. As used herein, a “coherent secondary unit” is defined as an agent that manages coherency by processing received requests and probes that target a corresponding memory controller. Additionally, as used herein, a “probe” is defined as a message passed from a coherency point to one or more caches in the computer system 300 to determine if the caches have a copy of a block of data and optionally to indicate the state into which the cache should place the block of data and/or trigger a write-back of dirty data in the cache.

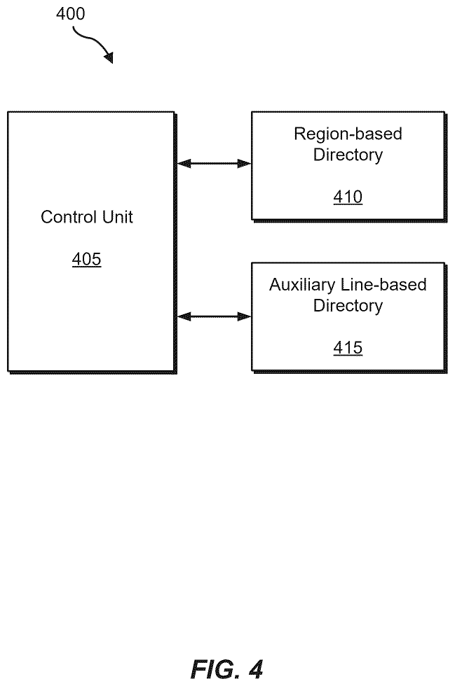

FIG. 4 is a block diagram of another implementation of a cache directory 400. In this implementation, cache directory 400 includes at least control unit 405 (e.g., a controller or circuitry) coupled to region-based cache directory 410 (e.g., a data structure) and auxiliary line-based directory 415 (e.g., a data structure). Region-based cache directory 410 includes entries to track cached data on a region-basis. In one implementation, each entry of region-based cache directory 410 includes a reference count to count the number of accesses to cache lines of the region that are cached by the cache subsystems of the computing system (e.g., system 300 of FIG. 3). In one implementation, when a region is accessed by multiple CPUs, the region will start being tracked on a line-basis by auxiliary line-based directory 415.

In one implementation, only shared regions that have a reference count greater than a threshold will be tracked on a cache line-basis by auxiliary line-based directory 415. A shared region refers to a region that has cache lines stored in cache subsystems of at least two different CPUs. A private region refers to a region that has cache lines that are cached by only a single CPU. Accordingly, in one implementation, for shared regions that have a reference count greater than a threshold, there will be one or more entries in the line-based directory 415. In this implementation, for private regions, there will not be any entries in the line-based directory 415.

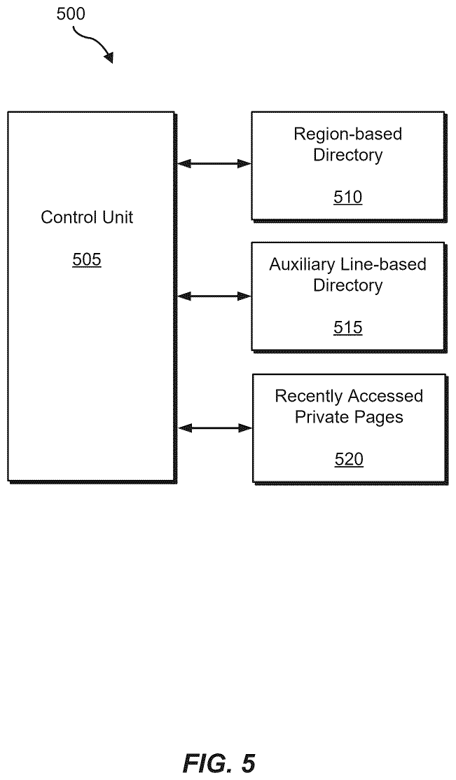

FIG. 5 is a block diagram of another implementation of a cache directory 500. In this implementation, cache directory 500 includes control unit 505, region-based cache directory 510, auxiliary line-based directory 515, and recently accessed private pages 520 for caching the N most recently accessed private pages. It is noted that N is a positive integer which can vary according to different implementations.

In one implementation, recently accessed private pages 520 includes storage locations to temporarily cache entries for the last N visited private pages. When control unit 505 receives a memory request or invalidation request that matches an entry in recently accessed private pages 520, control unit 505 is configured to increment or decrement the reference count, modify the cluster valid field and/or sector valid field, etc. outside of the directories 510 and 515. Accordingly, rather than having to read and write to entries in directories 510 and 515 for every access, accesses to recently accessed private pages 520 can bypass accesses to directories 510 and 515. The use of recently accessed private pages 520 can help speed up updates to cache directory 500 for these private pages.

In one implementation, I/O transactions that are not going to modify the sector valid or the cluster valid bits can benefit from recently accessed private pages 520 for caching the N most recently accessed private pages. Typically, I/O transactions will only modify the reference count for a given entry, and rather than performing a read and write of directory 510 or 515 each time, recently accessed private pages 520 can be updated instead.

Accordingly, recently accessed private pages 520 enables efficient accesses to the cache directory 500. In one embodiment, incoming requests perform a lookup of recently accessed private pages 520 before performing lookups to directories 510 and 515. In one embodiment, while an incoming request is allocated in an input queue of a coherent station (e.g., coherent secondary unit 320A of FIG. 3), control unit 505 determines whether there is a hit or miss in recently accessed private pages 520. Later, when the request reaches the head of the queue, control unit 505 already knows if the request is a hit in recently accessed private pages 520. If the request is a hit in recently accessed private pages 520, the lookup to directories 510 and 515 can be avoided.

As described herein a region-based directory (e.g., region-based directory 510) allows tracking larger caches without requiring a larger data structure for the directory. However, region-based tracking can lose fidelity compared to line-based tracking. In other words, region-based tracking loses the fine granularity of line-based tracking in order to track larger caches with fewer entries. Certain workloads, such as workloads with data sharing, exhibit certain particular lines being repeated and thus shared by multiple processing nodes. Such workloads can also exhibit empty entries as the shared line regions are tracked. In such instances, finer granularity tracking as provided herein can be advantageous. As will be described further below, a wide entry (e.g., a directory entry stored in more than one regular entry, such as a primary entry and one or more associated entries) can track a region as well as one or more lines in the region. In some examples, an available empty entry can be selected and designated as an associated entry, as will be described further below.

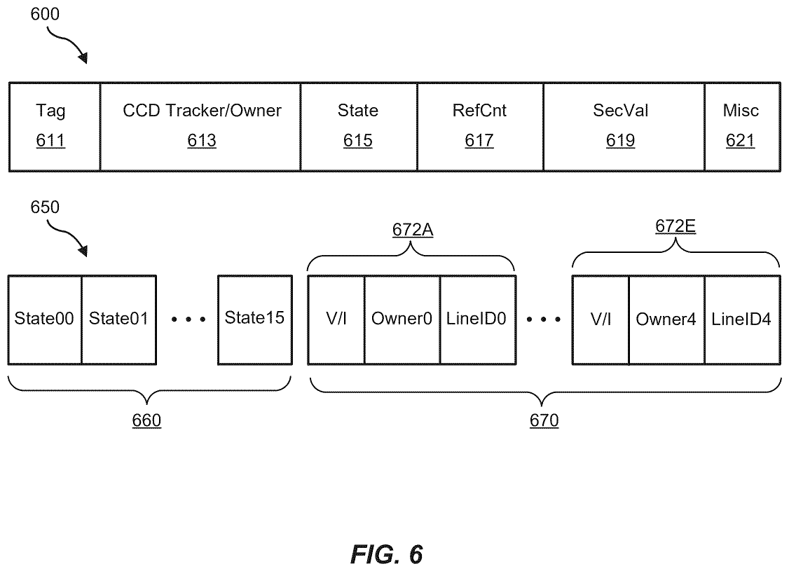

FIG. 6 is a block diagram of an implementation of an associated entry for a region-based probe filter directory. In this implementation, a region-based probe filter directory (not shown) includes a primary or regular entry 600 and an accompanying associated entry 650 among an array of entries. Regular entry 600 tracks regional instead of line information of a memory, thus is not for fine grained tracking. Associated entry 650 tracks additional information of lines within the region tracked by the corresponding regular 600, thus enhance the region-based probe filter directory tracking with line information to avoid false sharing and reduce the need for line-based probe filter directory. The false sharing refers to a situation in which two processing nodes access a same region—the region is shared according to the region-based probe filter directory, but the nodes are accessing different lines of the region—false sharing as no lines are actually shared.

Referring again to FIG. 6, in this implementation, regular entry 600 includes a tag field 611, a core complex die (CCD) tracker/owner field 613, a state field 615, a reference count (RefCnt) field 617, a sector valid (SecVal) field 619, and a miscellanea (Misc) field 621. In other implementations, the entries of the region-based probe filter directory can include other fields and/or can be arranged in other suitable manners.

Referring again to FIG. 6, tag field 611 includes the tag bits that are used to identify the entry associated with a particular cached memory region.

CCD tracker/owner field 613 is used to track the regular entry 600 to core complexes which own the cached data identified by the regular entry 600.

State field 615 includes state bits that specify the aggregate state of region. The aggregate state reflects the most restrictive cache line state for this particular region. For example, the state for a given region is stored as “dirty” even if only a single cache line for the entire given region is dirty. Also, the state for a given region is stored as “shared” even if only a single cache line of the entire given region is shared.

Reference count field (RefCnt) 617 is used to track the number of cache lines of the region which are cached somewhere in the system. On the first access to a region, an entry is installed in region-based probe filter directory and the reference count field 617 is set to one. Over time, each time a cache accesses a cache line from this region, the reference count is incremented. As cache lines from this region get evicted by the caches, the reference count decrements. Eventually, if the reference count reaches zero, the entry is marked as invalid, and the entry can be reused for another region. By utilizing the reference count field 617, the incidence of region invalidate probes can be reduced. The reference count filed 617 allows directory entries to be reclaimed when an entry is associated with a region with no active subscribers. In one embodiment, the reference count field 617 can saturate once the reference count crosses a threshold. The threshold can be set to a value large enough to handle private access patterns while sacrificing some accuracy when handling widely shared access patterns for communication data.

Sector valid field (SecVal) 619 stores a bit vector corresponding to sub-groups or sectors of lines within the region to provide fine grained tracking. By tracking sub-groups of lines within the region, the number of unwanted regular coherency probes and individual line probes generated while unrolling a region invalidation probe can be reduced. As used herein, a “region invalidation probe” is defined as a probe generated by the cache directory in response to a region entry being evicted from the cache directory. When a coherent moderator receives a region invalidation probe, the coherent moderator invalidates each cache line of the region that is cached by the local CPU. Additionally, tracker and sector valid bits are included in the region invalidate probes to reduce probe amplification at the CPU caches.

The organization of sub-groups and the number of bits in sector valid field 619 can vary according to the implementation. In one implementation, two lines are tracked within a particular region entry using sector valid field 619. In another implementation, other numbers of lines can be tracked within each region entry. In this implementation, sector valid field 619 can be used to indicate the number of partitions that are being individually tracked within the region. Additionally, the partitions can be identified using offsets which are stored in sector valid field 619. Each offset identifies the location of the given partition within the given region. Sector valid field 619, or another field of the entry, can also indicate separate owners and separate states for each partition within the given region.

Referring again to FIG. 6, in this implementation, associated entry 650 includes a group of line state information 660 and a group of line owner information 670. The group of line state information 660 exemplarily includes state information of 16 lines (State00-State15), which are all the lines in the region. Each of line state information 660 has exemplary two bits storing four states: I (invalid), S (shared), M (modified) and O (owned). These state bits are updated when line state changes. With up-to-date knowledge of the state of each line in the region, for example, the region probe filter does not need to send probes for not-shared clean lines.

The group of line owner information 670 exemplarily includes owner information of 5 lines 672A-E. For each line, the owner information includes a valid/invalid (V/I) bit, owner identification bits (e.g., Owner0), and line identification bits (e.g., LineID0). The owner identification bits identify a processing node that owns the data cached at the tracked line. The line identification bits identify the tracked line. For a particular implementation, the width of either regular or associated entries is fixed, therefore, line owner information 670 may not track all the lines in the region.

As shown in FIG. 6, regular entry 600 and associated entry 650 together form a wide entry tracking information for multiple lines inside a region, therefore, such wide entry is used for tracking a high fidelity region.

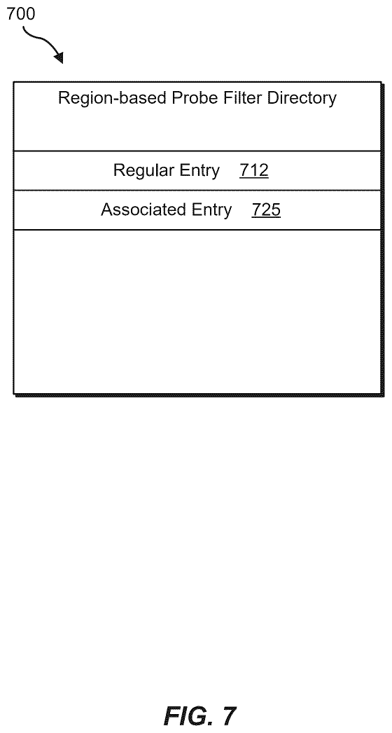

FIG. 7 is a block diagram of an exemplary region-based probe filter directory 700. In an implementation, the region-based probe filter directory 700 includes a regular entry 712 and its accompanying associated entry 725. The associated entry 725 is located next to the regular entry 712, for example having a subsequent address or index. In this way, the probe filter can identify the location of an associated entry without using a separate mapping table, although in some implementations, the probe filter can track associated entry 725 for regular entry 712 using a mapping table or list of associated entries.

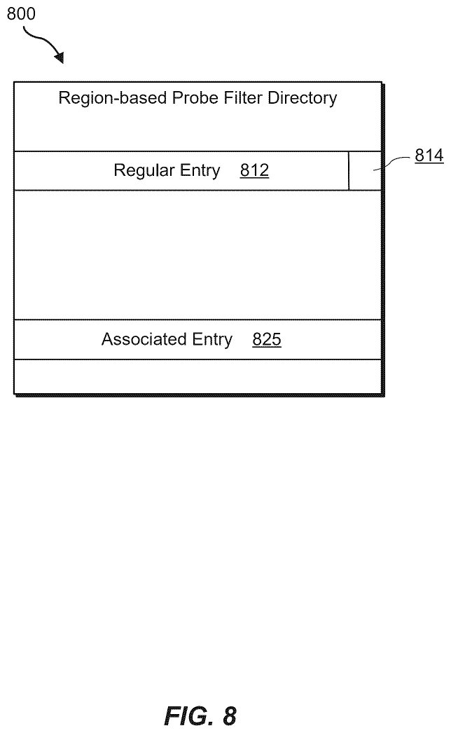

FIG. 8 is a block diagram of another exemplary region-based probe filter directory 800. In an implementation, the region-based probe filter directory 800 includes an exemplary regular entry 812 and its accompanying associated entry 825. The associated entry 825 is located at a pre-selected location which is pointed to by index bits 814 in regular entry 812. In an implementation, the pre-selected location is fixed and dedicated to associated entries. Index bits 814 are extra and not used bits in regular entry 812. The implementation shown in FIG. 8 using index bits 814 in regular entry 812 allows locating associated entry 825 without a separate lookup. An advantage of such implementation is the flexibility of able to select a location for associated entries. In some implementations, index bits 814 can be stored in a separate mapping table or list.

FIG. 9 is a flowchart illustrating an exemplary process 900 for constructing an associated entry. The process 900 begins with caching a memory region by a processing node such as node 305A (block 910). In response, a regular entry tracking the cached region is constructed in a region-based probe filter directory (e.g., region-based directory 510) corresponding to the processing node (block 920). At this time, all the information regarding the cached region is available to the probe filter controller (e.g., control unit 505), which then uses the information to immediately construct an associated entry (e.g., associated entry 650) accompanying the regular entry (e.g., regular entry 600) in the region-based probe filter directory if a slot therein is available (block 930). Therefore, the regular entry and the associated entry are effectively constructed simultaneously (e.g., at or near a same time). The associated entry can be located next to the regular entry as shown in FIG. 7. Alternatively, the associated entry can be located in a fixed pre-selected location as shown in FIG. 8.

According to process 900, every time a regular entry is constructed in a region-based probe filter directory, an accompanying associated entry is also constructed if there a slot is available. Similarly, every time a regular entry is updated, its accompanying associated entry is also updated.

When a regular entry is first constructed, the regular entry is privately owned by the accessing processing node. In such case, an associated entry is not needed. However, when the cached region transitions to a shared one, especially a falsely shared one, i.e., different processing node accessing different lines of the same region, the associated entry become useful in tracking different lines of the region.

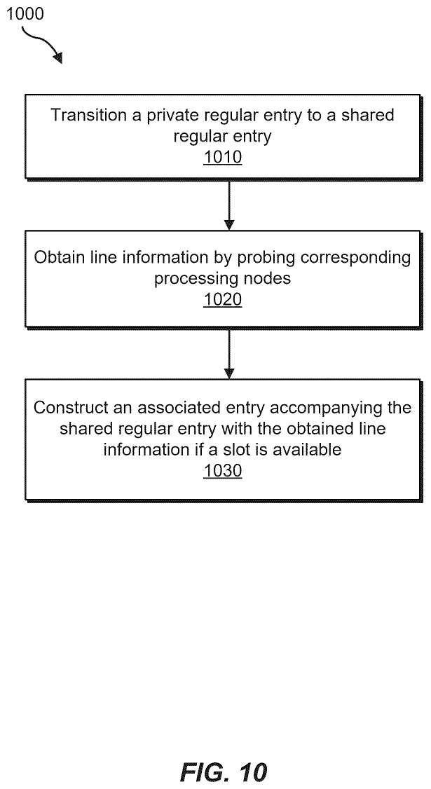

FIG. 10 is a flowchart illustrating another exemplary process 1000 for constructing an associated entry. The process 1000 begins with transitioning a private regular entry to a shared regular entry (block 1010). As line information are no longer available to the probe filter controller at this time, the probe filter controller needs to obtain the line information by probing corresponding processing nodes (block 1020). In an implementation, the probe filter controller sends a probeNOP (“NOP” refers to “no operation”) superprobe to figure out presence/state of the lines. However, such implementation requires a superprobe for every such transition, and more information will be passed to the coherent station unit (see FIG. 3).

Referring again to FIG. 10, once the line information is obtained, the probe filter controller constructs an associated entry accompanying the shared regular entry with the obtained line information if a slot in the region-based probe filter directory is available (block 1030). The associated entry can be located next to the regular entry as shown in FIG. 7. Alternatively, the associated entry can be located in a fixed pre-selected location as shown in FIG. 8.

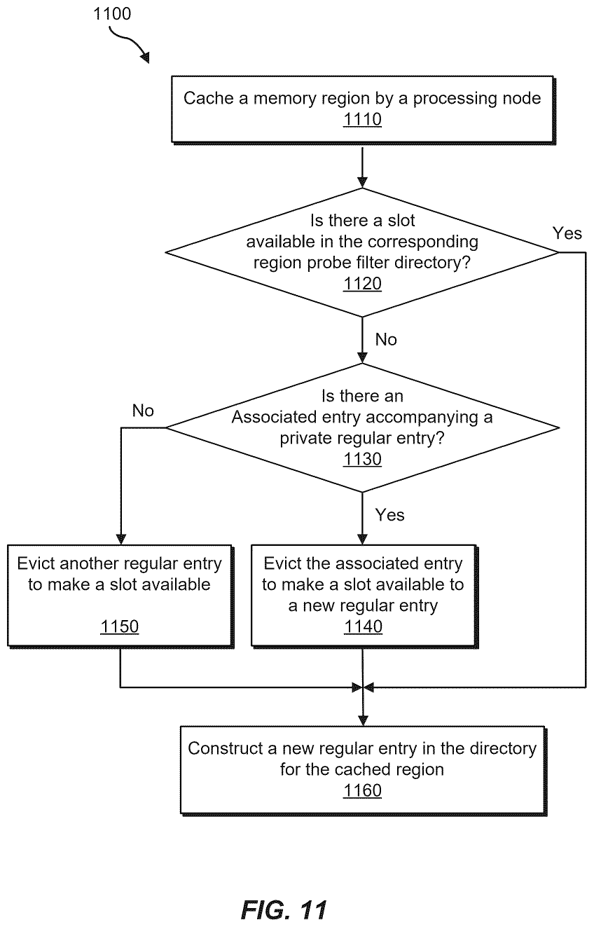

FIG. 11 is a flowchart illustrating an exemplary process 1100 of evicting an associated entry to make a slot available for a new regular entry in a region-based probe filter directory. Exemplary process 1100 begins with caching a memory region by a processing node (block 1110). A next step is for a corresponding probe filter controller to inquire if there is a slot available in a region-based probe filter directory corresponding to the processing node (block 1120). If a slot is available, process 1100 proceeds to construct a new regular entry in the directory for the cached region (block 1160). Otherwise, the probe filter controller inquires if there is an associated entry accompanying a private regular entry (block 1130), for example by determining if a neighboring entry is an associated entry or if the private regular entry has index bits pointing to the associated entry. If such associated entry exists, the probe filter controller evicts this associated entry to make a slot available to a new regular entry (block 1140). Otherwise, the probe filter controller picks another regular entry for eviction to make a slot available (block 1150). Process 1100 makes sure that private associated entries are evicted before any shared associated entry being evicted, as a private associated entry tracks lines accessed by only one processing node, there is less need for such an associated entry.

The present disclosure discloses a probe filter directory that contains a wide entry for tracking a high fidelity region. The wide entry includes a regular entry and an accompanying associated entry, which contains additional line information of the high fidelity region.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed. Any of the various compute systems described herein are configured to implement processes described herein.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a probe filter directory having a first and second entry, the first entry containing information of a first region of a memory, the second entry containing information of a line in the first region of the memory.

2. The device of claim 1, wherein the first entry contains a tag field pointing to the first region of the memory.

3. The device of claim 1, wherein the second entry contains state information of the line in the first region of the memory.

4. The device of claim 3, wherein the second entry is evicted of the line information to store information of a second region of the memory.

5. The device of claim 1, wherein the first and second entries are located next to each other in the probe filter directory.

6. The device of claim 1, wherein the first entry includes one or more bits pointing to a location of the second entry.

7. The device of claim 1, wherein the first and second entry are constructed simultaneously upon the first region being cached by a cache subsystem.

8. The device of claim 1, wherein the second entry identifies a first and second processing node each owning a line in the first region of the memory.

9. The device of claim 8, wherein the second entry is constructed upon the second processing node accessing the line in the first region of the memory.

10. The device of claim 1, wherein the probe filter directory is region-based such that entries are constructed in the probe filter directory in response to regional access of the memory.

11. A system comprising:
a processing node including one or more processors and a cache subsystem;
a region-based probe filter directory having a first and second entry, wherein the first entry includes a tag field pointing to a region of a memory, data stored in the region is cached in the cache subsystem, and the second entry includes state information of a line in the region of the memory.

12. The system of claim 11, wherein the second entry is evicted of the line information to store information of a second region of the memory.

13. The system of claim 11, wherein the first entry includes one or more bits pointing to a location of the second entry.

14. A method comprising:
constructing a first entry in a probe filter directory to track a first region of a memory; and
constructing a second entry in the probe filter directory to track a line in the first region of the memory.

15. The method of claim 14, wherein the first entry contains a tag field pointing to the first region of the memory.

16. The method of claim 14, wherein the second entry contains state information of the line in the first region of the memory.

17. The method of claim 16 further comprising evicting the state information of the line from the second entry and storing information of a second region of the memory in the second entry.

18. The method of claim 14, wherein the first entry includes one or more bits pointing to a location of the second entry.

19. The method of claim 14, wherein the second entry identifies a first and second processing node each owning a line in the first region of the memory.

20. The method of claim 19, wherein the second entry is constructed upon the second processing node accessing the line in the first region of the memory.
